(19) United States
(12) Patent Application Publication
(10) Pub. No.: US 2012/0032883 A1
(43) Pub. Date: Feb. 9, 2012

(54) COMPUTER MOUSE

(75) Inventor: SHUN-CHIEN LAN, Tu Cheng (TW)

(73) Assignee: Cheng Uei Precision Industry Co., LTD., Tu Cheng City (TW)

(21) Appl. No.: 12/850,573

(22) Filed: Aug. 4, 2010

(51) Int. Cl. G09G 5/08

(52) U.S. Cl. 345/163

(57) ABSTRACT

A computer mouse is connected to a host system and includes a mouse body, and a connecting unit, a function-key-inputting unit, a touch-screen module, and a control module assembled on the mouse body. The connecting unit connects the mouse body with the host system for signal communication. The function-key-inputting unit transmits function-key-inputting instructions to the host system via the connecting unit. The touch-screen module is provided for displaying graphical information and detecting input instructions. The control module receives the function-key-inputting instructions and signals of the touch-screen module and transmits the instructions and signals to the connecting unit. The mouse can provide both regular functionality of a typical mouse and touch-controlling functionality via the touch-screen module. Incorporating with the host system, the mouse can provide a keyboard function, a hand-writing function, and a search function for convenience of operating and using.

### BACKGROUND OF THE INVENTION

1. Field of the Invention

The present invention generally relates to an information-inputting device for an electronic product, and particularly to a computer mouse.

2. Description of Prior Art

Most computer systems, for example general purpose computers, including portable computers and desktop computers, receive inputs from a user via an input device, such as a mouse.

However, mice that are available in the current market provide limited functionalities and show no wide range of applications. When a user wishes to handle an image by processing both the whole image and details of specific parts of the image at the same time with a single display device, the user must repeat the operations of zoom in and zoom out frequently, and this is cumbersome and time consuming

### SUMMARY OF THE INVENTION

To solve the above-mentioned problem, an objective of the present invention is to provide a computer mouse, which is capable of touch-controlling functionality.

To achieve the above objective, the invention provides a computer mouse that is connectable to a host system and includes a mouse body, and a connecting unit, a function-key-inputting unit, a touch-screen module, and a control module assembled on the mouse body. The connecting unit connects the mouse body with a host system for signal communication. The function-key-inputting unit transmits function-key-inputting instructions to the host system via the connecting unit. The touch-screen module is provided for displaying graphical information and detecting input instructions. The control module receives the function-key-inputting instructions and signals output by the touch-screen module and transmits the instructions and signals to the connecting unit.

The mouse of present invention can provide both regular functionality of a typical mouse and touch-controlling functionality via the touch-screen module. Incorporating with a host system, the present invention provides a keyboard function, a hand-writing function, and a search function for convenience of operating and using.

### BRIEF DESCRIPTION OF THE DRAWINGS

The present invention may best be understood through the following description with reference to the accompanying drawings, wherein:

FIG. 1 is a block diagram of a computer mouse according to the present invention;

FIG. 2 is a diagram illustrating a structure of the computer mouse according to an embodiment of the present invention; and

FIG. 3 is a diagram illustrating a structure of the computer mouse shown in FIG. 1, wherein a cover is open.

### DETAILED DESCRIPTION OF THE PREFERRED EMBODIMENT

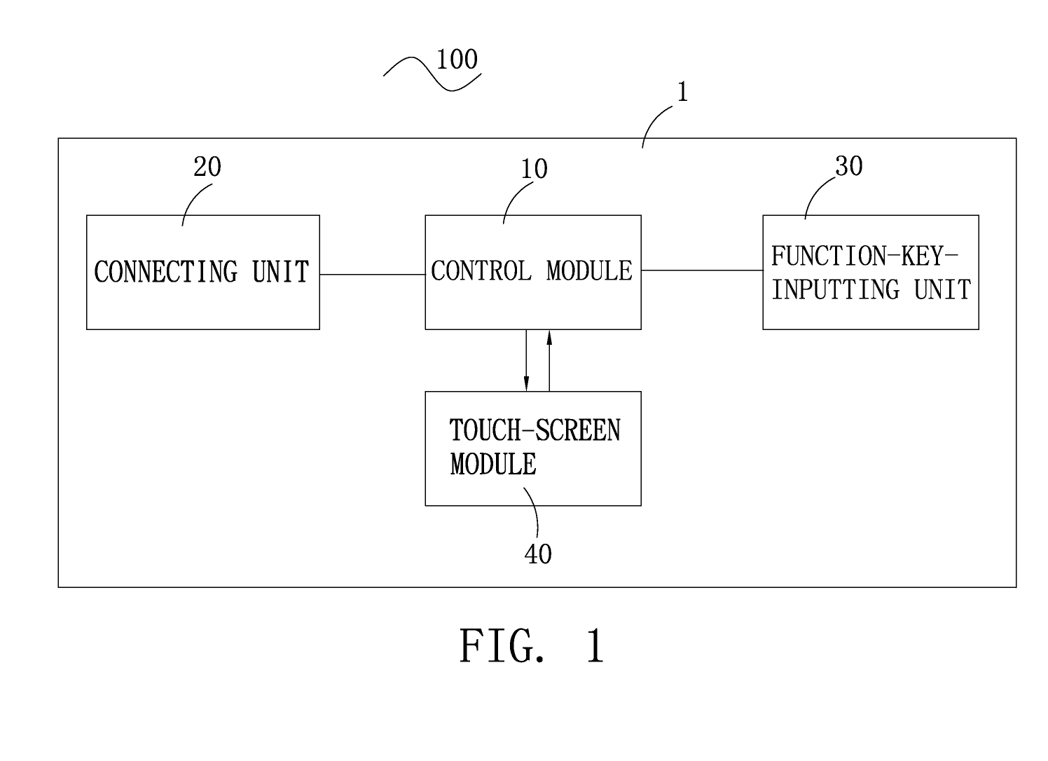

With reference to the drawings and in particular to FIG. 1, a computer mouse constructed in accordance with the present invention, generally designated at 100, is connectable to a host system, such as a computer system, and comprises a mouse body 1, and a control module 10, a connecting unit 20, a function-key-inputting unit 30, and a touch-screen module 40 assembled on the mouse body 1. The connecting unit 20 is connected to the control module 10. The control module 10 is coupled to the host system via the connecting unit 20 for signal communication. According to the present invention, the connecting unit 20 may be of wired or wireless connection. The touch-screen module 40 is assembled on the mouse body 1 and is connected to the control module 10 for displaying graphical information and detecting input instructions.

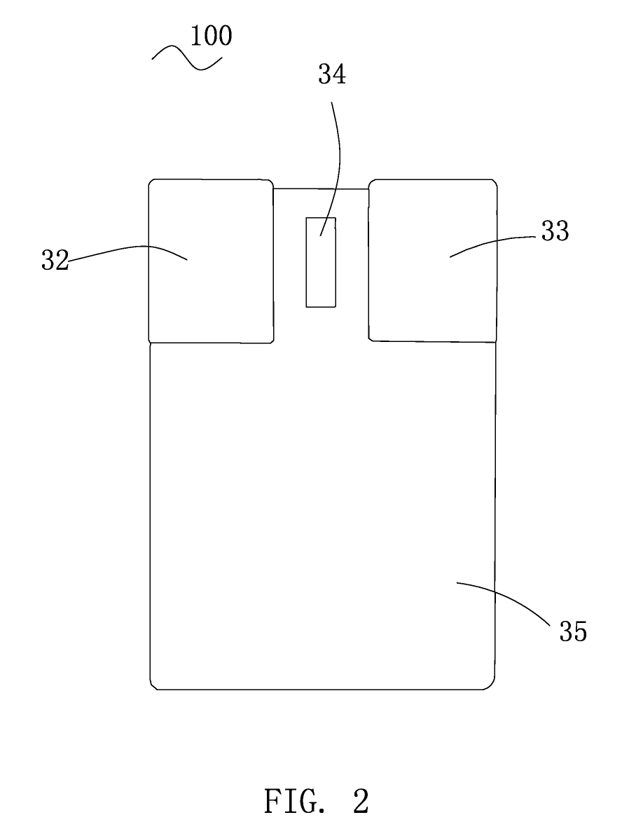

Referring to FIG. 2, the function-key-inputting unit 30 comprises a left button 32, a right button 33, and a scroll wheel 34. The left button 32 and the right button 33 are respectively mounted on the left and right sides of an end of the mouse body 1. The scroll wheel 34 is arranged on the mouse body 1 and is positioned between the left button 32 and the right button 33.

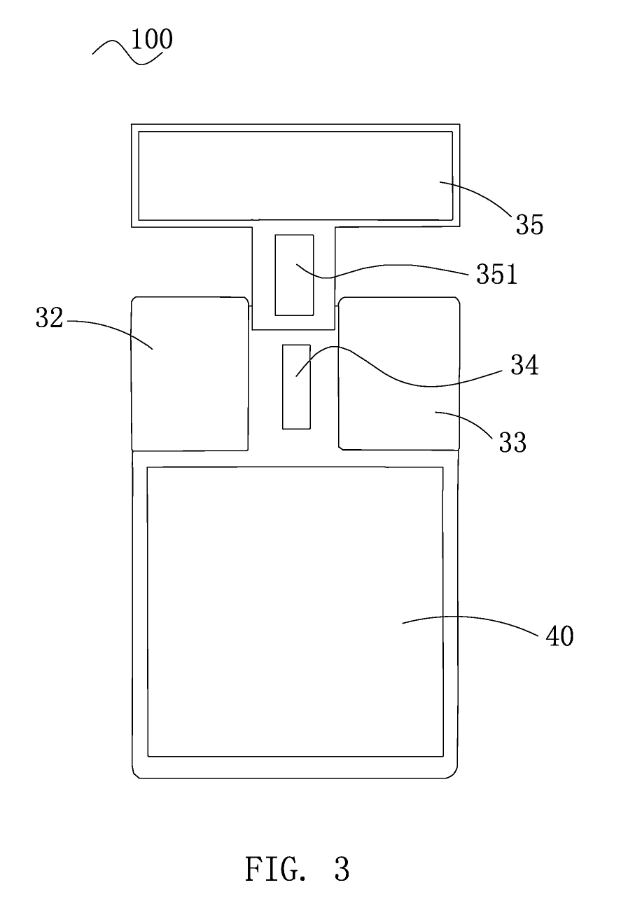

Referring to FIG. 3, the mouse body 1 carries a lid 35 thereon and a control switch (not shown) for turning on/off the touch-screen module 40. The lid 35 removably covers the touch-screen module 40 and controls activation and de-activation of the control switch. The lid 35 defines an opening 351. When the lid 35 is set to cover the touch-screen module 40, the scroll wheel 34 protrudes through the opening 351.

When the present invention is put into use, with the lid 35 of the computer mouse 100 closed, the computer mouse 100 of the present invention provides the same functionality as a typical mouse. When the lid 35 is open, the control module 10 detects if an angle formed between the lid 35 and mouse body 1 is wide enough. If the angle is not wide enough, then the control module 10 will detect whether the lid 35 is closed back. If it is closed, then the computer mouse 100 only will provide the same functionality as a typical mouse; otherwise, the control module 10 will re-detect the angle. If the angle is wide enough, such as an angle of 120 degrees or more in the preferred embodiment, then the touch-screen module 40 will be turned on for displaying a function selection menu of the computer mouse 100 and a plurality of shortcuts to programs for operating the host system. During turning on the touch-screen module 40, the left button 32, the right button 33, and the scroll wheel 34 of the computer mouse 100 are still in active status. That is, the computer mouse 100 provides both typical mouse functionality and functionality of the touch-screen module 40.

In the embodiment, the function selection menu of the touch-screen module 40 comprises multiple functions, such as a keyboard function, a hand-writing function, and a search function.

During turning on the touch-screen module 40, if the keyboard function is selected, the touch-screen module 40 will display a virtual keyboard for providing an input environment for users, whereby the users can input text to the host system. Input of text via the virtual keyboard is displayed on a primary displaying device of the host computer system.

If the hand-writing function is selected, the touch-screen module 40 will display a writing zone, and once hand writing is performed in the zone to input a character or word, the control module 10 determines if handwritten strokes of the input character or word are complete. If the handwritten strokes are complete, then the input result will be shown on the primary displaying device of the host computer system; otherwise, re-input is required.

If the search function is selected, the touch-screen module 40 will display a graphics originally displayed on the primary displaying device of the host system at a viewable field close to the computer mouse 100 to allow the touch-screen module 40 to carry out selection and edition of the graphics.

As described above, the present invention can provide both regular functionality of a typical mouse and touch-controlling functionality via the touch-screen module 40. Incorporating with a host system, the present invention can provide a keyboard function, a hand-writing function, and a search function for convenience of operating and using.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A computer mouse, which is adapted to connect to a host system, comprising:
a mouse body;
a connecting unit assembled on the mouse body and connecting the mouse body with the host system for signal communication;
a function-key-inputting unit assembled on the mouse body, for transmitting function-key-inputting instructions to the host system via the connecting unit;
a touch-screen module assembled on the mouse body for displaying graphical information and detecting input instructions; and
a control module assembled on the mouse body for receiving the function-key-inputting instructions and signals output by the touch-screen module and transmitting the instructions and signals to the connecting unit.

2. The computer mouse as claimed in claim 1, wherein the function-key-inputting unit comprises a left button, a right button, and a scroll wheel, the left button and the right button being respectively mounted on left and right sides of an end of the mouse body, the scroll wheel being arranged on the mouse body and between the left button and the right button.

3. The computer mouse as claimed in claim 1, wherein the mouse body comprises a lid removably set thereon and a control switch for turning on/off the touch-screen module, the lid removably covering the mouse body and controlling activation and de-activation of the control switch.
